(19) United States
(12) Patent Application Publication
(10) Pub. No.: US 2010/0259816 A1
(43) Pub. Date: Oct. 14, 2010

(54) Illumination device

(76) Inventor: Dieter Feger, Wien (AT)

Correspondence Address: HARNESS, DICKEY & PIERCE, P.L.C., P.O. BOX 8910, RESTON, VA, 20195, US

(21) Appl. No.: 12/662,219

(22) Filed: Apr. 6, 2010

(30) Foreign Application Priority Data
Apr. 8, 2009 (AT) A 555/2009

(51) Int. Cl. G02B 21/06

(52) U.S. Cl. 359/385

(57) ABSTRACT

An illumination device for an object to be examined through the objective of a microscope, comprises an illumination housing to be releasably connectable to a microscope. The housing extends along an axis and has two open front sides for the path of rays of the microscope's objective. For illumination, there is at least one light source which exhibits a plurality of light exits arranged in the illumination housing; wherein the light exits are inclined with respect to the axis of the housing. A translucent plate is connected to and removable from the illumination housing in a tool-free releasable manner so as to cover one of the open front sides as well as the light exits and to serve as a support surface for the object in the cases of dark-field illumination and back lighting bright field illumination.

### FIELD OF THE INVENTION

The present invention relates to illumination devices for illuminating an object to be examined through the objective of a microscope. In particular it relates to an illumination device which comprises a plurality of light exits from at least one light source. Such light source can either be of that type which sends light through light guides, preferably optical fibers, onto the object to be examined, or it comprises at least one, but preferably a plurality of light diodes. The light exits are in an illumination housing. Such housing is known to be releasably attachable to a microscope for dark-field illumination. It has two openings for allowing light to pass to the objective of the microscope.

### BACKGROUND OF THE INVENTION

When examining an object under a microscope's objective, there are different types of illumination, e.g. dark-field illumination from above, dark-field illumination from below or back lighting bright-field illumination, and for all these types of illumination, a separate illumination device is necessary which is specially adapted to the purpose. This causes much storing place necessary to keep the different types of illumination devices, and it causes costs for buying all them.

### SUMMARY OF THE INVENTION

It is an object of the invention to design an illumination device of the prior art in such a way that it is no longer necessary to change the device in order to enable either a bright-field illumination or a back lighting bright-field illumination in addition to dark-field illumination.

It is another object of the invention to make an illumination device of the type described more versatile and, thus, to reduce costs and storing place.

These objects are achieved according to the present invention in that a translucent plate is provided, which is attachable and removable from at least one of the openings of the illumination housing without the use of a tool and, thus, manually. The openings are so as to allow the path of rays of the microscope's objective to pass through, and form the open front sides of the illumination housing. The plate covers the illumination field of the light exits and serves as a support plate for the object to be examined in the cases of dark-field illumination from below or of transmitted bright-field-illumination (back lighting bright-field illumination).

With such a device according to the invention, an illumination device is provided that may be used for three different types of illumination, i.e. for dark-field illumination from above, dark-field illumination from below and back lighting bright-field illumination, which is simple in construction and is easy to use, because it is only necessary to attach the translucent plate to the illumination housing or to remove it.

According to a preferred embodiment of the invention, the illumination housing comprises a holding surface in the region of at least one of the open front sides to hold the plate, the surface of the translucent plate being the support surface for the object to be examined. “In the region” means that the translucent plate is in the opening (e.g. forming virtually the front surface of the housing) or is just above the opening. In this way, the illumination device can be made very compact and may be used as an illuminating object table.

As a further embodiment, it is suggested that the illumination housing surrounds a cavity, and the light exits are situated in this cavity, wherein preferably the light exits are situated in the interior of the illumination housing at a distance from that edge which forms the housing's opening. When arranging the light exits, which may either be the light exits of optical fibers or the light exits of light diodes, at a distance from the edge, in other words immerged in the housing's interior, they are better protected against damaging.

The illumination device can be made in a simple, stable and cost-efficient way, if, in accordance with a further characteristic of the present invention, the illumination housing comprises two cylindrical walls concentrically arranged to one another and leaving a hollow space between them, wherein the light exits are arranged in this hollow space.

According to a preferred characteristic of the invention, the translucent plate has a frame which holds the plate by a gripping surface and the frame has at least one connecting surface to be manually and releasably fixed to the illumination housing. In this way, a laboratory worker can easily retrofit the illumination device for different types of illumination with his own hands and without using a tool.

As a further embodiment of the invention, it is suggested that a reflector may be provided for reflecting light to the microscope's objective, wherein the illumination housing comprises at least one holding surface for receiving and holding the reflector. Alternatively, the reflector can be arranged below the housing. Such a reflector directs advantageously light, which is not directly emitted to the object, to the translucent plate and to the object and, in addition, homogenizes light to be directed to the object.

According to a further characteristic of the invention, the reflector comprises a reflector frame which cooperates with at least one holding surface of the illuminating housing in such a way so as to be manually and releasably fixed to it and being interconnected to the reflector through another gripping surface of the reflector's frame. In this way, the reflector can easily manipulated, i.e. attached or removed, without using a tool It is clear that the reflector's frame may be designed in a similar or analogous way as the frame of the plate.

In order to be able to adjust the brightness of light at the object, in the case of a dark-field illumination from below, or in the case of back lighting (transmitted) bright-field illumination, or to adjust the height in which the object is under the microscope's objective, an embodiment of the invention may be used, wherein either the plate's frame and/or the reflector's frame is composed of (at least) two concentric pipe ends being displaceable with respect to one another.

If, in accordance with another characteristic of the invention, either the plate and/or the reflector are manually releasably connected to the respective frame, the plate or the reflector may be removed from its frame and may be replaced by other components, e.g. a fresnel lens and/or a colored plate, depending on the requirements of a special illumination.

In order to make a higher light intensity or a different light direction possible, it is suggested, according to a further embodiment of the invention, to provide a supplemental housing for accommodating an additional illuminating arrangement, e.g. at least one light diode, and the illumination housing comprises an engagement surface for receiving the supplemental housing or part of it within its cavity.

In this connection, it may be useful, if electrical contacts are provided on the illumination housing and the supplemental housing for transferring electrical energy, wherein the additional illuminating arrangement comprises light diodes supplied with the transferred electrical energy. In this way, it is only necessary to assemble the two housings, and there is automatically a contact provided.

To adapt the light to the requirements of the examination, the translucent plate may either be formed with an opal plate surface and/or with a colored surface and/or with a fresnel lens.

Thus, the invention provides a modular illumination device for different types of illumination for microscopes wherein light exits in a single housing may be combined with a removable translucent plate and/or a removable reflector and/or with a supplemental housing with an additional illumination arrangement.

### BRIEF DESCRIPTION OF THE DRAWINGS

Further characteristics and advantages will become apparent from the following description of embodiments schematically illustrated in the drawings, in which

FIG. 1 shows a microscope comprising an illumination device attached to the objective for carrying out a dark-field illumination from above;

FIG. 2 represents a microscope, where the illumination device is on the basis for carrying out a dark-field or bright-field transmitted illumination;

FIG. 3 illustrates a view from below of an illumination device with annularly arranged light diodes;

FIG. 4 is a cross-section along the line A-A of FIG. 3 showing the illumination device when mounted on an objective of a microscope;

FIG. 5 is a cross-section of a first embodiment of the illumination device when arranged on the microscope's basis and equipped with the translucent plate;

FIG. 6 is a cross-section of a second embodiment of the illumination device when arranged on the microscope's basis and equipped with the translucent plate and a reflector; and

FIG. 7 is a cross-section of a second embodiment of the illumination device which shows a supplemental housing having additional light diodes.

### DETAILED DESCRIPTION OF THE INVENTION

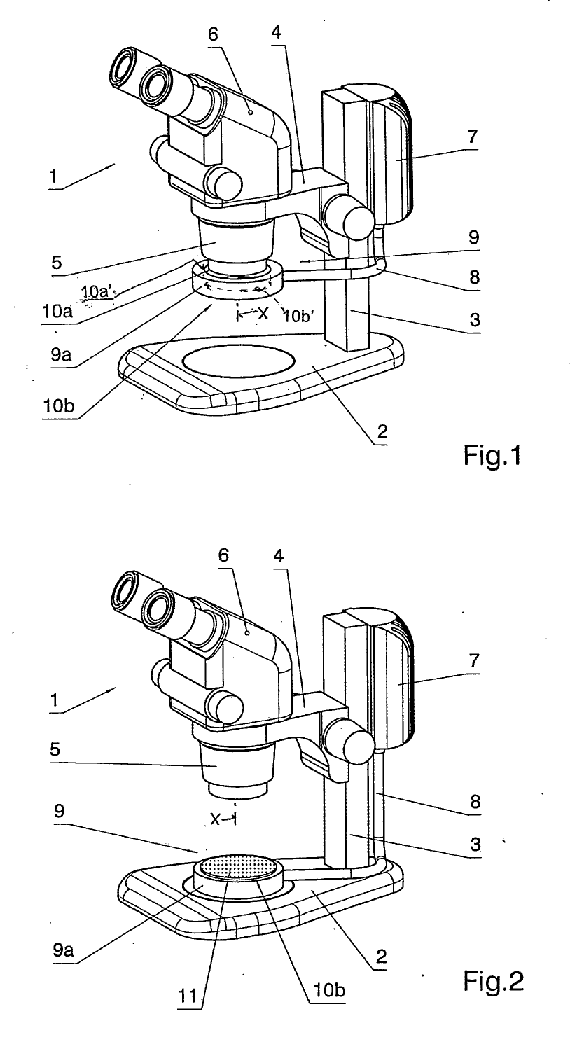

In FIG. 1, 1 designates a stereo-microscope which comprises a microscope base or bottom plate 2, a microscope pedestal 3 and a holding arm 4 for an observation system 6 which includes an objective 5 having an axis X. An object (not shown) to be examined will be put onto the microscope base or the bottom plate 2 below the objective 5.

An electric light source 7 is arranged on the microscope pedestal 3, and is equipped either with a halogen cold-light reflector lamp or with a high-power light diode (not shown). Light is introduced into a housing 9a of an illumination device 9 by means of a bundle of optical fibers situated in a hose 8, light exits of the optical light guide fibers being arranged in an annular shape on the inner wall of the housing 9a shaped as a hollow cylinder in a similar way, as it is represented in FIG. 5, where the light exits 12′ are the light exit surfaces of diodes (instead of optical fibers).

The objective 5 of the microscope 1 projects through an opening 10a surrounded by an upper edge 10a′ and, if so adjusted, through a lower opening 10b surrounded by an edge 10b′ (shown in dotted lines) of the housing 9a. As mentioned above, the light exits of the optical fibers are similar to those of diodes 12 shown in FIG. 5, i.e. the optical fibers of bundle 8 extend up to the place, where light exits 12′ are illustrated in FIG. 5. Housing 9a is preferably manually releasably mounted on the objective 5, as will be explained below.

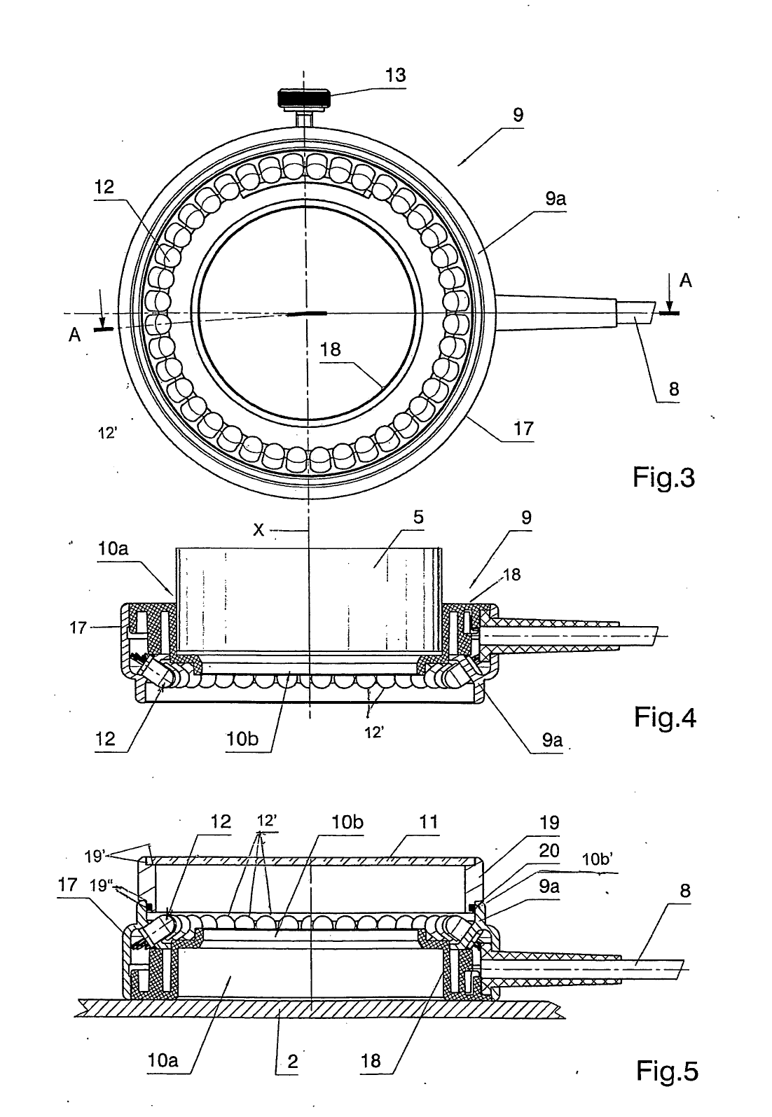

Light exits of the optical fibers (not shown in FIG. 1, but analogous to light exits 12′ of light diodes 12 in FIGS. 3 to 5) are inclined to the axis X of the objective 5 and towards the microscope base 2 (vide the arrangement in FIG. 4), and with such an arrangement dark-field illumination from above towards an object to be examined and lying on the microscope base 2 can be carried out. Preferably, light exits are immerged in the housing (vide FIG. 4 or 5).

As mentioned above, the housing 9a should preferably be manually releasably (and without the use of a tool) attached to the tube of the objective 5, e.g. by a clamping screw 13, as shown in FIG. 3.. However, the housing 9a could also be mounted on the microscope on the holding arm 4, on the pedestal 3 or on any stable component of the microscope 1.

Alternatively, the illumination device 9 can be used for dark-field illumination from below as well for bright-field transmitted illumination of the object to be examined. To this end, the housing 9a is inverted and laid onto the microscope base (vide FIGS. 2 and 5) so that opening 10b is upwards directed towards the objective 5, while opening 10a is on the microscope base 2.

In order to be able to support the object above the housing 9a, the opening 10b is covered by a plate 11, as shown in FIG. 2. This plate 11 is of a translucent material and may be formed as an opal plate, with a micro-prism surface, as a clear glass plate, as a fresnel lens, as a color filter (where at least its surface is colored), or the like or a combination of them. Moreover, this plate 11 may be equipped with light impermeable masks, by which one or more areas can be shadowed or chosen. As may be seen in FIG. 5, plate 11 is inserted into the housing 9a from above so as to sit and to be held by a staged gripping surface 19′. In this way, the plate 11 is manually releasable and removable in a simple manner without using a tool, which is of a particular advantage for storing and/or exchanging the plate 11, for example if an object shall be examined using different color plates 11.

In the flexible hose or rigid tube 8, electrical conductors or wires may be arranged instead of optical light guides or fibers (or in addition to them) for supplying at least one light source, but preferably a series of light diodes (vide FIGS. 4 and 5) which are arranged within the housing 9a of the illumination device 9, the light exits of them (as in the case of the light exits of light fibers) being directed both to the axis X of the objective and to the object to be examined. Component 7 attached to the microscope pedestal 3 houses the electronic stages necessary for supplying energy to the light diodes of the illumination device 9.

In the following embodiments, each component of a similar function will have the same reference numeral.

FIGS. 3 and 4 illustrate an illumination device 9 comprising a housing 9a which is composed of (at least) two substantially cylindrical walls 17 and 18 coaxial to one another, a plurality of light diodes 12 being in a space between these walls 17 and 18. As mentioned above, energy supply is effected through electrical conductors or wires in the hose 8, which are then connected to each individual light diode or to annular contacts arranged around axis X in FIG. 4, which are, in turn, contacted by the light diodes 12.

FIG. 4 shows a cross-sectional view of the illumination device along line A-A of FIG. 3. Although there is the clamping screw 13 (not visible in the cross-section of FIG. 4), FIG. 4 makes clear that there is another possibility to make the housing 9a easily and manually attachable and removable from the tube of objective 5: If the housing's inner wall 18 consists of an rubber elastic material, it can be frictionally attached to the lower end of the objective and even be adjusted in height. In any case, in this position, the objective 5 projects through the opening 10a (in this case being the upper opening) of the housing 9a so that the path of rays of the objective along the axis X passes through the opening 10a and 10b down to the object (not shown) lying beneath.

However, for dark-field illumination from below or for back lighting (transmitted) bright-field illumination, the illumination device 9 is removed from the objective, inverted and laid onto the microscope base, as shown in FIG. 5, so that the (formerly lower) opening 10b is now upwards directed and toward the objective. The opening 10b is then covered by the translucent plate 11.

In an advantageous manner, the plate 11 comprises a frame 19 in the form of a hollow cylinder (although other, e.g. multi-cornered shapes are also possible) This frame 19 hase a, preferably staged, connecting surface 19″ so as to be able to be plugged into the housing 9a. As in the case of gripping surface 19′, the staged shape has the advantage to provide an abutment stop. As is seen in FIG. 5, the connecting surface has preferably an elastic member, such as a sealing ring or O-ring to be frictionally held. This is another possibility of providing a manually releasable interconnection. The height of the frame 19 is chosen in a manner so that light emitted under a relative large angle from the annularly arranged light diodes 12 illuminates the plate 11 as uniformly as possible from below, thus illuminating the respective object which is lying on the plate 11.

As mentioned above, the cylindrical frame 19, for releasably attaching the translucent plate 11 to the housing 9a, comprises a staged or stepped annular connecting surface 19″, and between this step and the inner surface of the outer wall 17 of the housing 9a is a ring 20 of an elastic material. Of course, it would also be possible to have the ring 20 in a groove of the upper edge of the housing which surrounds the opening 10b. Likewise it would be possible to provide a similar ring at the gripping surface 19′. Of course, manually releasable fixation can also be obtained in many other fashions, for example by elastic clamps, which e.g. act from above (and are for removal pivotal around an axis, or by leaf springs holding the rim of the plate 11 and so on.

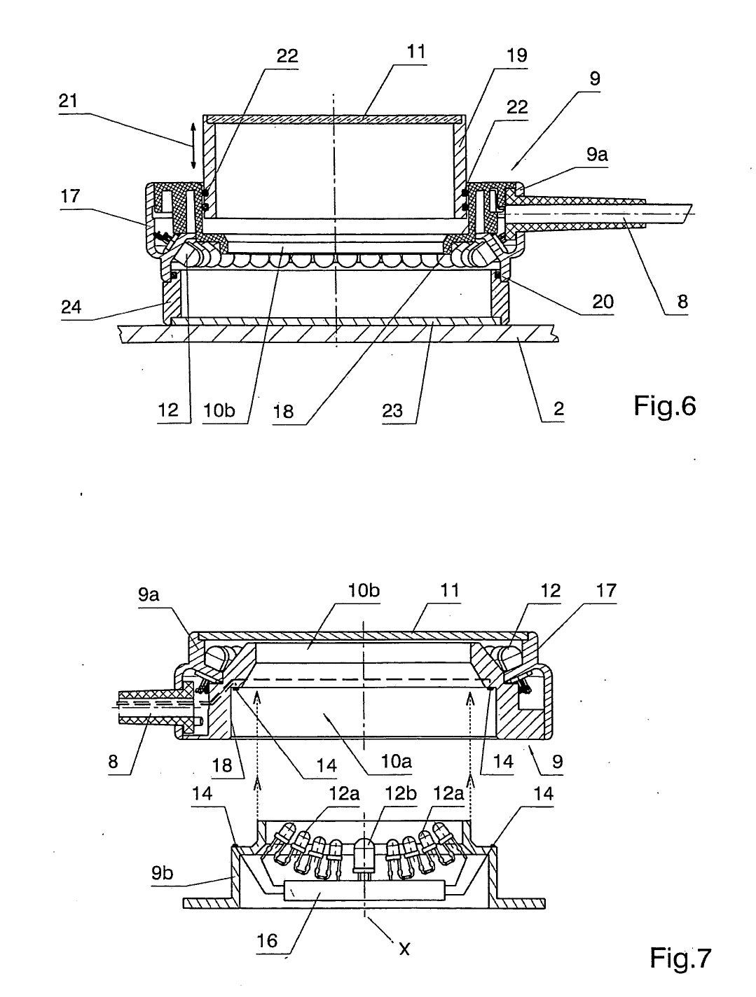

In contrast to the embodiment and arrangement of the illumination device described with reference to FIG. 5, the illumination device 9 of FIG. 6 is lying on the microscope base 2 in such a manner that the light exits of light diodes 12 are inclined towards the microscope base 2 so that light reaches the plate 11 only as light reflected from the microscope base 2 or from a reflector plate, as will be described later.

According to FIGS. 5 and 6, the upper opening 10a of the housing 9a is covered by the translucent, (mostly) circular plate 11, and the plate 11 is preferably surrounded by a frame 19. As long as releasable fastening is done using a clamping screw 13 (FIG. 3), the width of the frame 19 of FIG. 6 may be larger than that of FIG. 5. The diameter of the frame 19 is smaller than the diameter of the inner cylindrical wall 18 of housing 9a, and the glass plate 11 with its frame 19 is inserted so as to be displaceable in height within the opening 10a of housing 9a, as indicated by arrow 21. Suitably elastically deformable rings 22, preferably of rubber or plastic material, are provided and sit, in particular, in grooves of the outer surface of the frame. This embodiment with two pipe ends displaceable one in the other and relative to one another enables manually releasable clamping of the translucent plate 11 including the frame 19 at any height desired.

Opening 10b of housing 9a is covered by a reflector 23 which is put onto the outer wall 17 of the housing 9a (e.g. in an analogous manner as is plate 11). This reflector 23 is preferably equipped with a cylindrical frame 24 which may be formed in a similar manner as the frame 19, described above with reference to FIG. 5. In any case, frame 23 is manually releasably attachable to the housing 9a without using a tool. The upwards directed inner wall of the reflector 23 has a reflective coating either by being metallized or by having a white surface. In a similar manner, the inner wall of the frame 23, but optionally the inner wall of frame 19 of FIG. 5 or 6, may be metallized or may have a white surface.

The dimensions and the geometry of the housing 9a and of the translucent plate 11, of the frames 19 or of the reflector 23 may be chosen in such a way, that different combinations are possible together with the housing 9a, i.e. the translucent plate 11 together with its frame 19 as well as the reflector 23 together with its frame 23 may be put over either opening 10a or 10b of the housing 9a which bears the light exits either of light fibers or diodes as light sources so that different illuminations of an object to be examined are possible.

Instead of rings 20 or 22 of an elastic material, other clamping or holding devices may be provided which enable manual releasable fixing of the components of the illumination device 9. Apart from the possibilities mentioned above, a bayonet coupling, a spring biased ball catch or the like may be provided.

In FIGS. 3, 4, 5 and 6, the light exits 12′ are arranged in a single annular row. However, within the scope of the invention, there may be other light exits either in concentric rings along axis X or in a single plane or in segments or sectors of the housing 9a.

In FIG. 7, a further embodiment of an illumination device 9 is represented, which comprises for the purpose of a dark-field illumination from below or for back lighting (transmitted) bright-field illumination of an object, a further or supplemental housing 9b may be provided as a support for further light exits of light fibers or, preferably, of light diodes 12a and/or for a single light diode 12b as an additional illumination device. This constitutes a further combination facility with housing 9a.

This supplemental housing 9b is positively plugged (see dotted arrows) into the cylindrical inner wall 18 of housing 9a which is complementary to the outer shape of the supplemental housing 9b. Current supply to light diodes 12a, 12b is suitably effected through electric contacts 14 provided on both housings 9a and 9b so that with plugging the supplemental housing 9b into the housing 9a, the electrical contact is automatically effected.

For certain examinations of an object, the light source 12b, which is situated just at the central axis X (which is also the longitudinal axis of the objective 5) of the illumination device 9 may be advantageous, and it may, likewise, be convenient to have several switches for activating only some groups of light diodes 12a. Control of such switches or the switches themselves may be provided in or on an electronic component 16 within the supplemental housing 9b. The switches, in the position shown in FIG. 7, may then be operated from below.

Depending upon the examination to be carried out, the illumination device 9 may be equipped with light diodes which emit a colored light, or it may be convenient to combine light diodes which emit different sorts of light, such as differently colored light.

The supplemental housing 9b is an adapter for increasing light intensity in the case of dark-field illumination from below or for back lighting (transmitted) bright-field illumination of an object. This adapter, which is formed of the supplemental housing 9b and the light diodes 12a, 12b, may be used as a spot illumination of the object to be examined, even independently from the illumination 9, in case it is desired for a certain object illumination.

As indicated above, the shape of the housing 9a of the illumination device 9 is not restricted to an annular shape. In plan view, it can be polygonal and e.g. have the shape of a rectangle, a square; pentagon, hexagon or octagon.

The arrangement may also be such, that the illumination device 9, for dark-field illumination from below or for back lighting (transmitted) bright-field illumination, may also be supported within a recess of the microscope base 2 (so as to center it), and the recess may deep enough, that the upper surface of the translucent plate 11 of the illumination device 9 is in the plane of the upper surface of the microscope base, which is facing the objective 5 of the microscope.

It is clear that the present invention is not restricted to the embodiments shown and described, but may be modified, for example as mentioned above or by combinations with features of the prior art.

What is claimed is:

1. Illumination device for an object to be examined through the objective of a microscope, comprising
illumination housing means to be releasably connectable to a microscope, said housing extending along an axis and having two open front sides for the path of rays of the microscope's objective, said front sides being defined by a surrounding edge;
illuminating means including at least one light source having a plurality of light exits arranged in said illumination housing; said light exits being inclined with respect to said axis;
plate means being translucent and being connected to and removable from said illumination housing means in a tool-free releasable manner so as to cover one of said open front sides as well as said light exits and to serve as a support surface for said object in the cases of dark-field illumination and back lighting bright field illumination.

2. Illumination device as claimed in claim 1, wherein said illumination housing means comprise holding means in the region of at least one of said open front sides to hold said plate means.

3. Illumination device as claimed in claim 1, wherein said illumination housing means surrounds a cavity, said light exits being situated in said cavity.

4. Illumination device as claimed in claim 3, wherein said light exits are situated in the interior of said illumination housing means at a distance from said edge.

5. Illumination device as claimed in claim 1, wherein said illumination housing means comprise two cylindrical wall means concentrically arranged to one another leaving a hollow space between them, said light exits being arranged in said hollow space.

6. Illumination device as claimed in claim 1, further comprising first frame means having a first gripping surface for said plate means, said first frame means having at least one connecting surface to be manually and releasably fixed to said illumination housing means.

7. Illumination device as claimed in claim 6, wherein said first frame means comprise two concentric pipe ends being displaceable with respect to one another.

8. Illumination device as claimed in claim 6, wherein said first gripping surface is manually releasable from said plate means.

9. Illumination device as claimed in claim 1, further comprising reflector means for reflecting light to said objective, said illumination housing means comprising at least one holding surface for receiving and holding said reflector means.

10. Illumination device as claimed in claim 9, wherein said reflector means comprise second frame means cooperating with said at least one holding surface so as to be manually and releasably fixed to it and being interconnected to said reflector means through a second gripping surface of said second frame means.

11. Illumination device as claimed in claim 10, wherein said second frame means comprise two concentric pipe ends being displaceable with respect to one another.

12. Illumination device as claimed in claim 10, wherein said second gripping surface is manually releasable from said reflector means.

13. Illumination device as claimed in claim 1, further comprising supplemental housing means for housing additional illuminating means, said illumination housing means comprising an engagement surface for receiving at least part of said supplemental housing means within said cavity.

14. Illumination device as claimed in claim 13, wherein at least one of said illuminating means and said additional illuminating means comprise at least one light diode.

15. Illumination device as claimed in claim 13, further comprising electrical contact means on said illumination housing means and said supplemental housing means for transferring electrical energy, said additional illuminating means being light diodes supplied with said transferred electrical energy.

16. Illumination device as claimed in claim 1, wherein said plate means comprise an opal plate surface.

17. Illumination device as claimed in claim 1, wherein said plate means comprise a fresnel lens.

18. Illumination device as claimed in claim 1, wherein said plate means comprise a colored surface.

19. Illumination device as claimed in claim 1, wherein said illuminating means comprise light guide means extending between said light source and said illumination housing.

20. Illumination device as claimed in claim 1, wherein said illuminating means comprise at least one light diode.
